(19) United States
(12) Patent Application Publication
(10) Pub. No.: US 2008/0040352 A1
(43) Pub. Date: Feb. 14, 2008

(54) Method for creating a disambiguation database

(76) Inventor: Kenneth Alexander Ellis, Hoboken, NJ (US)

Correspondence Address: ELLIOT FURMAN, 15 WEST 81ST STREET #11J, NEW YORK, NY, 10024, US

(21) Appl. No.: 11/463,061

(22) Filed: Aug. 8, 2006

(51) Int. Cl. G06F 17/30

(52) U.S. Cl. 707/10

(57) ABSTRACT

A disambiguation database is created from a digital encyclopedia database. The digital encyclopedia database comprises a plurality of pages. A list of pages of the digital encyclopedia database is obtained. It is determined if each page of the list is a disambiguation page or a redirect page. For each disambiguation page or redirect page, a page type is determined and a page popularity is computed. The disambiguation database comprises links to redirect pages, links to disambiguation pages, page popularities, and page types. The disambiguation database may be used to disambiguate entities that have been extracted from an article.

### BACKGROUND

Digital Encyclopedia Databases

Digital encyclopedias have been around for many years. Some of the earliest digital encyclopedias were sold on CD-ROMs to consumers for use on their personal computers. These digital encyclopedias were more easily kept up-to-date than their printed counterparts, and were certainly more convenient. An entire encyclopedia, including all text and images from every volume, could be conveniently stored on a single CD-ROM, and the entire encyclopedia could be easily searched on the personal computer.

With the advent of the Internet, these digital encyclopedias were made available on-line, that is they were stored as a database on an Internet connected computer. In this way, anyone with access to the Internet could search the digital encyclopedia database for items of interest. Additionally, the digital encyclopedia database could be enhanced by linking to resources on other Internet connected computers. Examples of digital encyclopedia databases are Encyclopedia Britannica Online (http://www.britannica.com/) and MSN Encarta (http://encarta.msn.com/). Many other digital encyclopedia databases are available online, some having content of a general nature, and other having highly specialized content in the area of law, medicine, history, and the like.

In recent years, collaboratively written digital encyclopedia databases have grown in popularity, and have become some of the most widely referenced digital encyclopedia databases. A collaboratively written digital encyclopedia is an online digital encyclopedia database written by contributors from all over the world. The content may include text, images, and links to other entries in the digital encyclopedia database as well as to other web pages on the Internet. The content of the digital encyclopedia database is edited by the many contributors to the database. In this way, on average, submissions to the database are kept up to date, unbiased in tone, and factually correct. One example of an digital encyclopedia database is Wikipedia® (Wikipedia is a registered trademark of the non-profit Wikimedia Foundation) which can be accessed at the web address http://www.wikipedia.org. Wikipedia is just one of many other collaborative database of the Wikimedia Foundation. Just a few examples of other databases include Wiktionary, a multiple language dictionary and thesaurus, Wikiquote, a free compendium of quotations, Wikinews, a collaboratively written news site, and Wikibooks, a collection of open content textbooks. These and other Wikimedia databases are accessible at http://wikimedia.org. Wikimedia is just one example of some of the digital encyclopedia databases available online. Many others are available for free under many license and models such as the Creative Commons license and the GNU Free Documentation License (GFDL).

Entity Extraction

Entity extraction, or named entity extraction, refers to information processing methods for extracting information such as names, places, and organizations from machine readable documents. One example of a machine readable document is an on-line article. For example, an on-line article may be a news story available on the Internet from Internet connected news server.

As is well known, articles are displayed in a web browser on a client computer simply by typing in the web address, referred to more broadly as a universal resource identifier (URI), of any of the news servers. News servers may serve news from thousands of online local, regional, national, and international news outlets supplying news from sources such as Agence France-Press (AFP), Reuters, Associated Press (AP), Los Angeles Times, New York Times, USA Today, National Public Radio (NPR), CNN.com, Slashdot.org. There are many other news servers where Internet users can receive news from, such as Yahoo! News (http://news.yahoo.com) and Google News (http://news.google.com). These and other similar websites sometimes do not generate any original news content, but they aggregate news from a multiplicity of news servers, thus providing a convenient way for Internet users to view articles from a multiplicity of sources from a single website.

An article may be a news article or any other type of article, whether or not it contains current news. The article may comprise aggregated content from a multiplicity of other articles. An article comprises text, with at least some of the text comprising entities. The article may further comprise an image or images, links to audio and video, embedded audio and video, links to other articles, links to web pages and blogs, and the like. As used herein, the term “web browser content” is understood to mean, either by themselves or in combination, text, an image or images, links to audio and video, embedded audio and video, links to other articles, links to web pages and blogs, and other types of content that are displayable or accessible in a web browser.

Entity extraction can be applied to an article to extract entities such as names of people, places, and organization. Dates, time, and numerical quantities such as monetary values may also be extracted. For example, entities in an article on a political subject may include people entities such as the U.S. President, senators, news commentators, and the like. It may also include organization entities such as the Pentagon, the White House, or a corporation such as Halliburton. It may also include places entities such as the United States, Iraq, and Baghdad.

Many well understood linguistic, knowledge-based, statistical, probabilistic, and hybrid methods for entity extraction may be employed, and currently are in prior art implementations. In one embodiment Hidden Markov Models are used. In other embodiments, rule-based methods, machine learning techniques such as Support Vector Machine learning methods, and Conditional Random Fields are implemented either by themselves or in combination.

There are many commercial products available employing these and other techniques, for example IdentiFinder™ from BBN Technologies, products from Basis Technology Corp., Verity Inc., Convera, and Inxight Software Inc.

Freely available software for developing and deploying software components that process human language include GATE (General Architecture for Text Engineering, http://gate.ac.uk), and OpenNLP (http://opennlp.sourceforge.net), which is a collection of open source projects related to natural language processing. These methods, models, algorithms, systems, and products are well understood by those of ordinary skill in the art and are routinely used to extract entities from on-line content such on-line articles, as well as content that is not available on-line such as private databases and files.

Ambiguous Entities

One significant issue facing prior art entity extraction implementations is word sense ambiguity. For example, if the extracted entity is the word “cold”, does “cold” refer to a temperature or a viral infection? Or, if the extracted entity is the word “Bush”, does “Bush” refer to U.S. president George W. Bush, a plant such as a shrub, or Vannevar Bush? (Vannevar Bush was an engineer at the Massachusetts Institute of Technology (MIT) and played an important role in the development of the atomic bomb during World War II. He developed the first modern analog computer, called a Differential Analyzer, which could solve certain classes of differential equations. His work at MIT lead to the development by one of Bush's graduate students, Claude Shannon, of digital circuit design theory.) Various techniques have been implemented in the prior art to disambiguate entities. Most of these include statistically analyzing the words that surround the extracted entity, and sometimes supervised learning techniques such as Support Vector Machines that require large amounts of training data before they are at all useful. A full survey of disambiguation techniques is disclosed in the paper “Word sense disambiguation: The state of the art”, Ide, N. and Vronis, J. (1998), Computational Linguistics, 241, pp. 1-40, which is hereby incorporated by reference.

The most successful of these and other prior art disambiguation techniques are oftentimes extremely computationally intensive, and the less computationally intensive disambiguation techniques oftentimes provide poor results. It would therefore be advantageous if there were a new way of disambiguating entities that had high accuracy and low computational requirements.

### SUMMARY

A method creating a disambiguation database is disclosed. The disambiguation database is created from a digital encyclopedia database. The digital encyclopedia database comprises a plurality of pages. Each page comprises content, including a page body, a title, characters, and links. Providing the digital encyclopedia database, a list of the plurality of pages of the digital encyclopedia database is obtained. And, for each page, the content and links are obtained. Next, for each page of the list of pages, it is determined if the page is a disambiguation page or a redirect page. To determine if the page is a disambiguation page or a redirect page, the content of the page is searched. Then, for each disambiguation page and redirect page, a page type is determined, and the popularity of the page is estimated. Links to redirect pages, links to disambiguation pages, the popularity of pages, and the page types are stored in the disambiguation database.

The foregoing paragraph has been provided by way of general introduction, and it should not be used to narrow the scope of the following claims. The preferred embodiments will now be described with reference to the attached drawings.

### BRIEF DESCRIPTION OF THE DRAWINGS

FIG. 1 is a method for disambiguating an entity.

FIG. 2 is a prior art method for providing an entity from an article.

FIG. 3 is an exemplary disambiguation page.

FIG. 4 is a redirect page pointing to the disambiguation page of FIG. 3.

FIG. 5 is an exemplary encyclopedia page.

FIG. 6 is a redirect page pointing the encyclopedia page of FIG. 5.

FIG. 7 is a method for creating a disambiguation database.

FIG. 8 is a method to determine if a page of an encyclopedia is a redirect page or disambiguation page.

FIG. 9 is a method for determining a page type.

FIG. 10 is a method for estimated a popularity of a page.

### DETAILED DESCRIPTION OF THE PRESENTLY PREFERRED EMBODIMENTS

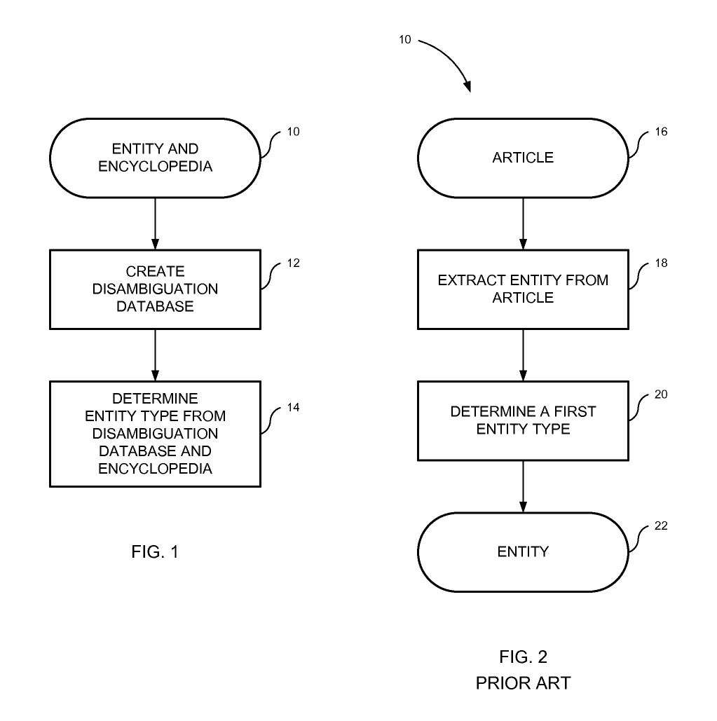

FIG. 1 shows a method for disambiguating an entity. An entity is provided 10. The entity is an ambiguous entity as discussed above with reference to the ambiguous entity example “Bush”. The entity may be provided in any number of ways. In one way, entities are extracted from an on-line article using any of the prior art entity extraction methods described above. The prior art entity extraction methods may also optionally determine a first entity type, that is, a first guess as to whether the entity is a person, an organization, a location, or some other type of entity. FIG. 2 shows one prior art method for providing the entity (10 of FIG. 1). First, an article is provided 16, then entities are extracted from the article 18, next a first entity type is determined 20 for each of the extracted entities, and finally the entity is provided 22 to be disambiguated according to the steps of FIG. 1.

The reliability of the first entity type determination can vary widely depending on the entity, the article, and the prior art entity extraction implementation. Typically, the extraction process will result in many errors, and create the same entity in several forms, for example “Bush”, “George Bush”, and “George W. Bush”.

A digital encyclopedia database, hereinafter referred to as an “encyclopedia”, is also provided (10). In one embodiment the encyclopedia is a collaboratively written on-line encyclopedia such as Wikipedia.

As a matter of background, the encyclopedia comprises a plurality of pages, with each page typically covering a different topic. For an on-line encyclopedia, the pages are accessible via Internet connected client computers and viewable via a web browser on the client computer. The pages, and any content of the pages and structure of the pages, are therefore accessible, readable, parseable, modifiable and the like, by any conventional means such application programming interfaces (API) like the Document Object Models (DOM), or other various well know methods of accessing, reading, parsing, modifying, processing, and the like, of HTML, XHTML, XML, and other web readable or executable code, scripts, languages, and the like.

Each page of the plurality of pages of the encyclopedia is comprised of content elements such as a page title, a page body, and links (universal resource locators or universal resource identifiers). These and other elements are comprised of a multiplicity of alpha-numeric characters. The characters may also make up other elements of the page such tags, meta-tags, embedded scripts and commands, markup elements, and the like The pages may also include content such as graphics, audio, images, applets, video, and any other embeddable or web readable or executable content.

Continuing, as a matter of background, each page is also categorized according to its subject. For example, a page discussing Benjamin Franklin is categorized as a person page, and a page discussing the United States Patent and Trademark office is categorized as an organization page. Some pages may have more than one category.

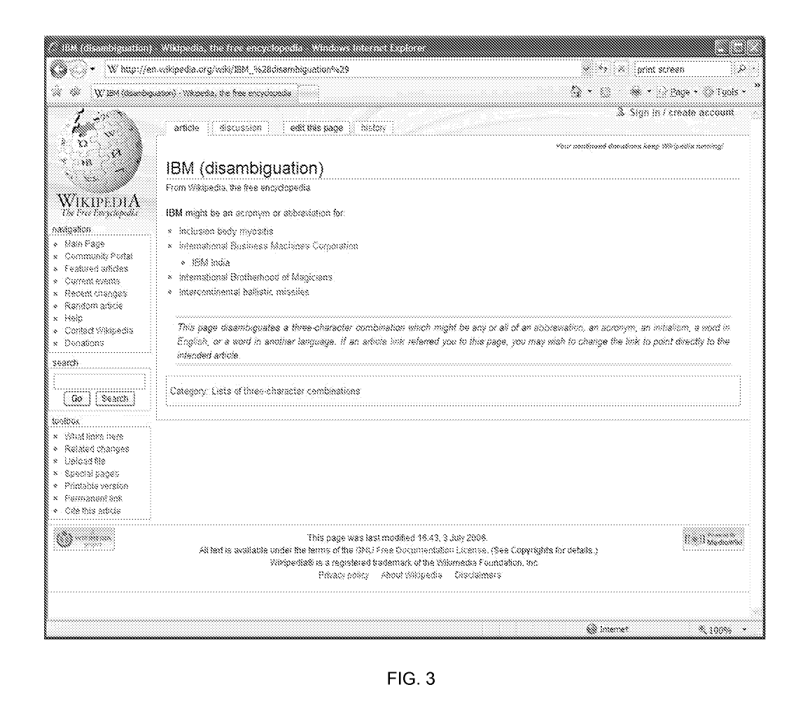

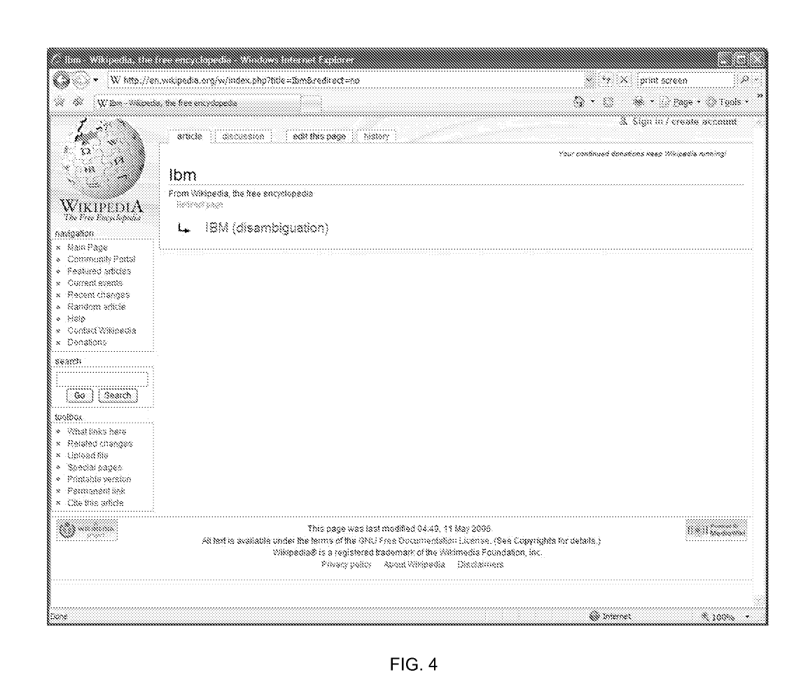

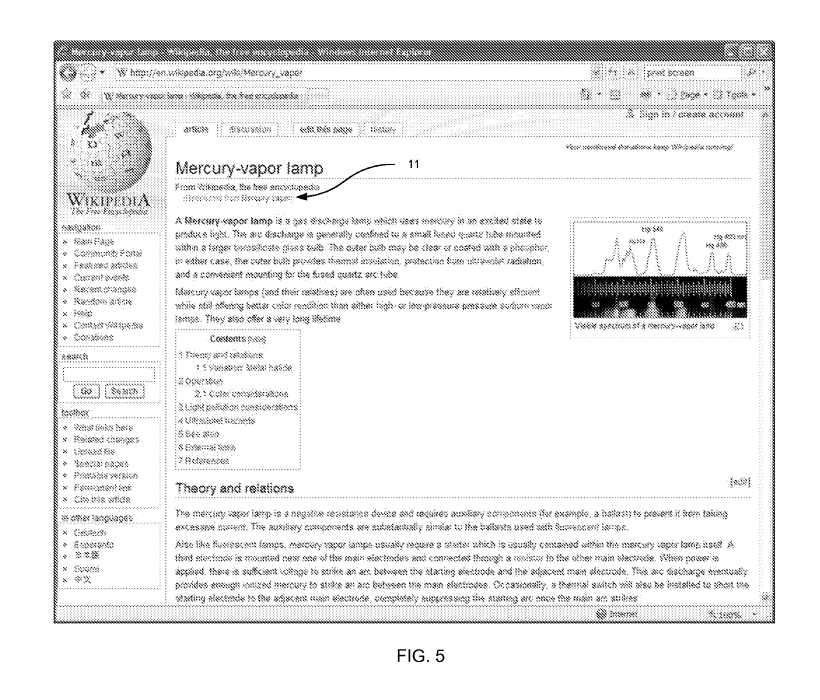

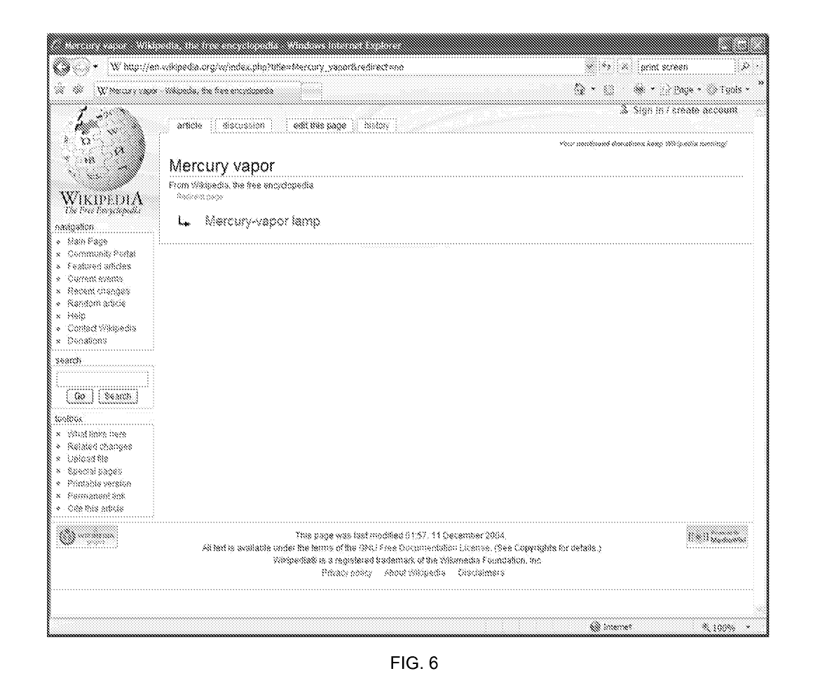

A page can be marked as a disambiguation page or a redirect page. For example, searching for the term “ibm” in Wikipedia displays a disambiguation page showing that “IBM” may refer to “Inclusion body myositis”, “International Business Machines”, or “International Brotherhood of Magicians” (FIG. 3), and a user may then navigate to any of these pages. The IBM redirect page is shown in FIG. 4 and is the page that points to the IBM disambiguation page of FIG. 3. As another example, searching on the term “mercury vapor” redirects to the page entitled “Mercury-vapor lamp” (FIG. 5). The page indicates that the search was redirected (11 of FIG. 5). The redirect page is shown in FIG. 6. There is no disambiguation page since there is only one entry in the encyclopedia for the term “mercury vapor”, and thus searching on “mercury vapor” automatically displays the “Mercury-vapor lamp” page. Embedded within the code comprising the page are tags such “#REDIRECT” or “#DISAMBIGUATION” or other equivalent tags. Different databases may use different tags, or other markers, code, text, and the like for indicated whether a page is a redirect or disambiguation page. The tags ““#REDIRECT” or “#DISAMBIGUATION” are exemplary and it is appreciated by those skilled in the art that any tag, marker, code, text, and the like is compatible with the present invention.

Turning back to FIG. 1, a disambiguation database is created (12) and the entity type is determined (14) from the disambiguation database and the encyclopedia. Briefly, the disambiguation database is created from the encyclopedia (10) through a series of simple and quickly computable steps that include simple text searches of the encyclopedia, and performing simple calculations based on a number of links such as inbound links (IL) and outbound links (OL) comprising each page in the encyclopedia. Further, the entity type is determined along with a score indicating the likelihood the entity type is correct through a series of simple and quickly performed queries of the disambiguation database and computations involving direct links and indirect links between pages of the encyclopedia.

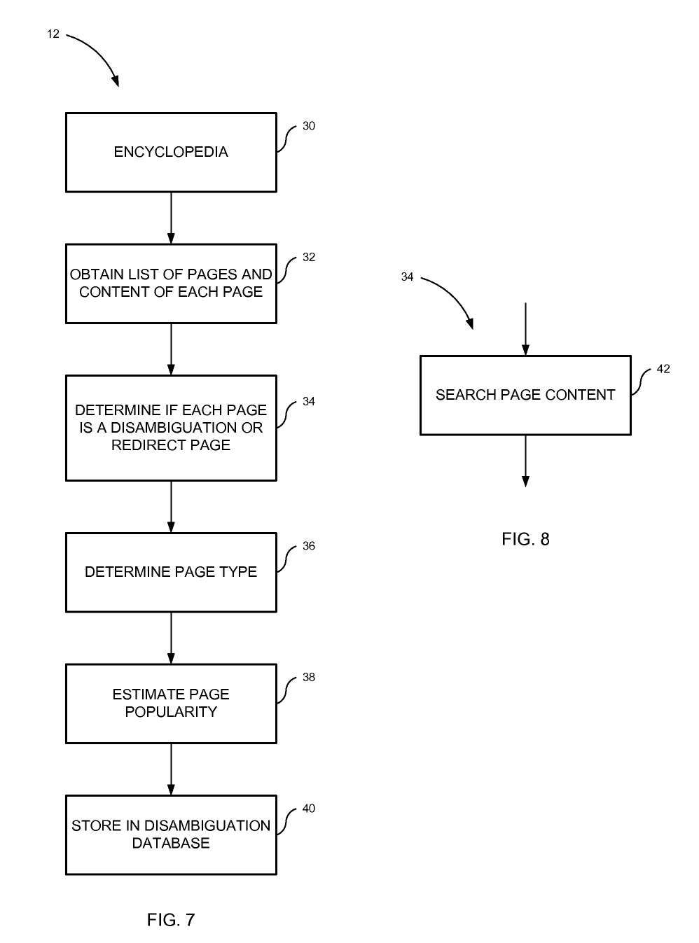

A method for creating the disambiguation database 12 of FIG. 1 is shown in FIG. 7. A digital encyclopedia database is provided (30). The encyclopedia comprises plurality of pages. Each page includes content comprising characters, a page body, a title, and links. A list of pages is obtained and the content, including the links, is obtained (step 32). Next, for each page of the list of pages, it is determined if each page is a disambiguation page or redirect page, or neither (step 34). Then, for pages which are not disambiguation or redirect pages, a page type is determined (step 36). In one embodiment, the page type is a person page, an organization page, or neither. Then, the popularity of each page is estimated (step 38), and various results from the previous steps (30, 32, 36, 38, 40) are stored in a disambiguation database (step 40).

Examining the steps in closer detail, a list of pages is obtained (32) from the provided digital encyclopedia database (30). Typically, the encyclopedia database is stored on an Internet connected server, and is accessible via the Internet from an Internet connected client computer. Accessing databases over the Internet via client-server interactions is well understood in the art.

Next, after the list of pages is obtained (32), for each page of the list of pages, it is determined if the page is a disambiguation or redirect page, or neither. The page type is quickly and easily determined by searching the page content (42 of FIG. 8) of the page of the encyclopedia pointed to by the list of pages obtained in step 32. In step 32, and in fact with any reference herein to obtaining content, it is understood that obtaining content is understood to encompass actually downloading or otherwise obtaining the complete content from a server storing the encyclopedia database, as well as accessing it from a client computer but not necessary capturing or storing content from the encyclopedia database. In one embodiment using Wikipedia, a complete copy of the encyclopedia is published by the Wikimedia Foundation.

Turning back to step 34 of FIG. 7 and step 42 of FIG. 8, in one embodiment, the page is a designated a disambiguation page if the title of the page comprises the word “disambiguation”, or the page comprises any of a number of disambiguation tags, such as “#DISAMBIGUATION”. The page is designated a redirect page if the pages comprises the word or tag “#REDIRECT”. The content is searched (42) in a case insensitive manner, so the word “disambiguation” is equivalent to the word “DISAMBIGUATION”, as is “#redirect” equivalent to “#REDIRECT”. Searches for other words or tags that indicate a page is a redirect or disambiguation page are also possible, and the specific search will depend on the type and format of the pages of the encyclopedia. It is also noted, that some or all searches of content, of the encyclopedia, or of any other database may be case insensitive.

If the page is a disambiguation or redirect page, that is it is not a “neither” page, for each page, the page type is determined (step 36 of FIG. 7). The page type may comprise any of a number of page types. For example, two exemplary page types include a person page, and an organization page. Other page types are possible, such as a location page. If the page is neither a disambiguation nor a redirect page, the page is skipped, that is, it is not important for the creation of the disambiguation database.

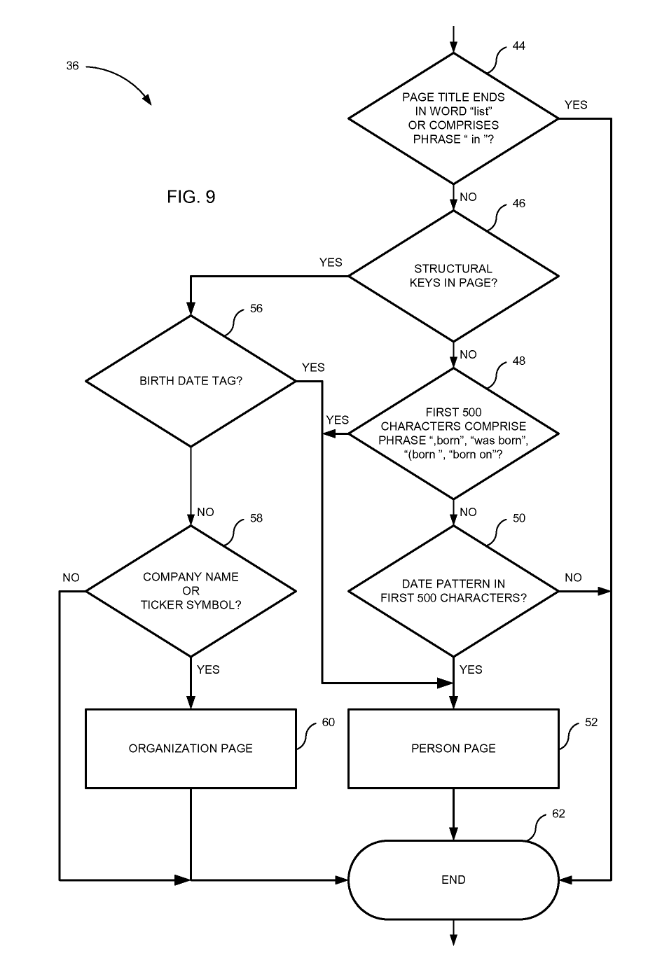

One detailed exemplary flowchart showing how to determine the page type is shown in 36 of FIG. 9. In this example, a page type is determined to be either a person page type or an organization page type. This occurs after it is verified that the page is either a disambiguation or redirect page (34 of FIG. 7). It will become evident to those skilled in the art that the steps of 36 in FIG. 9 may be adapted to determine other page types. It is appreciated that the particular steps shown in FIG. 9 will differ depending on the encyclopedia and format of pages to be searched. However, it is also appreciated that such modifications to any of the steps of FIG. 9 are well within the scope of the present inventions, and shall be treated as equivalent to the steps disclosed herein. In the particular example of FIG. 9, the encyclopedia and encyclopedia pages provided in step 30 of FIG. 7 are from Wikipedia.com.

Examining now the steps shown in FIG. 9, the page title is searched and the page is skipped if the page title ends in the word ‘list’ or comprises the phrase ‘in ’ (step 44). That is, the page is not a disambiguation page.

If the page title does not contain these words or phrases, next, the structural keys of the page are searched (step 46). Structural keys are part of the page content, and are for example, tags, metatags, or embedded information in the code that makes up the page. Examples of specific structural keys include the tag ‘birth_date’ in the header of the page, the tag ‘company name’ in the header or body of the page, and a ticker symbol such as ‘{{XXXX|’ in the header or body of the page (where ‘XXXX’ is replaced with a ticker symbol of a company). So in one example, if a birth date tag is present then the page is a person page, or if the company name tag or ticker symbol is present, then the page is an organization page.

Continuing, after step 44, if structural keys are not found (step 46), the first five hundred characters are searched for the phrase, ‘born’, ‘was born’, ‘(born’, or ‘born on’ (step 48). If none of the these phrases are found, then a data pattern is searched for in the first five hundred characters (step 50). Exemplary date patterns include ‘(1924-2005)’, ‘(1924 to 2005)’, ‘May 5, 1924-Apr. 30, 2005)’, ‘(May 5, 1924—)’ and other equivalent variations. If a date pattern is not found then the page is skipped, and is recorded as neither a person page, nor an organization page.

Referring back to step 46, if the page comprises structural keys, tags, or patterns which indicate that it is a person page, then the page is identified as a person page (step 52). If it is not identified as a person page, then the page is searched for a company name or ticker symbol (step 58). If either are present, the page is identified as an organization page (step 60). If neither identification is made, the page is skipped and is neither an organization page nor a person page.

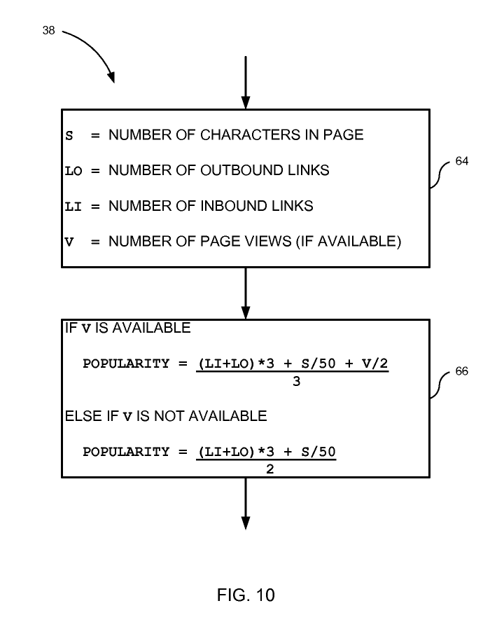

Turning back to FIG. 7, after determining the page type (step 36), the page popularity is estimated (step 38). Referring to step 64 of FIG. 10, the popularity is estimated according to a computation using the size S of the page in characters, the number of pages to which it links, LO (also called outbound links), and the number of pages linking to it, LI (also called inbound links). If available, either through a page counter or some other prior art means, the number of page views or the amount of traffic to the encyclopedia, V, may also be included in the computation. All of these variables are quickly ascertainable.

Referring to step 66, if V is available, the popularity, P, is computed by evaluating the formula P=((LI+LO)*3+S/50+V/n)/3. In one embodiment n=2. In another embodiment n=S_{avg}/(25*V_{avg}). If V is not available, P=((LI+LO)*3+S/50)/2. Variations on the specific computation of P are also possible while remaining within the scope of the present invention.

Looking back at FIG. 7, a disambiguation database is created in step 40 by storing results from the previous steps. Specifically, the following is stored in the disambiguation database: links to redirect pages, links to disambiguation pages, and for each redirect and disambiguation page, the popularity, P, of the page and the page type, which, in one example comprises either a person page or an organization page.

The disambiguation database is typically stored on an Internet connected computer. The computer may be any conventional type of computer, such as an Intel or AMD based computer, and may run any conventional operating system such as Linux or Windows. The database may be any conventional database such as a MySQL or Access database. Computers, databases, writing and reading databases, querying databases, and the like are well understood by those of ordinary skill in the art.

Note that as disclosed above, even a very large encyclopedia can easily and quickly be process to create a disambiguation database. And, as will be disclosed separately, the disambiguation database may be accessed to disambiguate entities in an efficient, accurate, an computationally non-intensive manner.

Briefly, the disambiguation database may be queried for extracted ambiguous entities from an article. Direct and indirect links for page matches in the disambiguation database are counted by accessing the pages of the encyclopedia pages pointed to by the matches. A score is computed from the direct and indirect links, and the score is adjusted according to the popularity P of the matches in the disambiguation database. The entity is then disambiguated, that is a determination is made as to what type of entity it is (for example a person or an organization) according to the score, and page type of page matched in the disambiguation database. Methods of disambiguating entities will be disclosed separately in detail

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

What is claimed is:

1. A method for creating a disambiguation database from a digital encyclopedia database, the digital encyclopedia database having a plurality of pages wherein each page includes content comprising a page body, a title, characters, and links, the method comprising the steps of:
(a) providing a digital encyclopedia database;
(b) obtaining a list of the plurality of pages, and for each page the content, including the links;
(c) for each page of the list of pages, determining if the page is a disambiguation page or redirect page;
(d) if each page is a disambiguation or redirect page,
(d1) determining a page type; and
(d2) estimating a popularity of the page.

2. The method of claim 1 further comprising storing in a disambiguation database links to redirect pages, links to disambiguation pages, and for each redirect page and disambiguation page, the popularity of the page and the page type.

3. The method of claim 1 wherein said determining in (d1) comprises determining if the page type is a person page or an organization page;

4. The method of claim 3 wherein said determining in (d1) comprises analyzing the page according to the steps of, in the sequence set forth:
(e1) skipping the page if the page title ends in the word ‘list’ or comprises a phrase comprising the phrase ‘in ’;
(e2) searching for structural keys, wherein if the structural key is a birth date tag then the page is a person page, and if the structural key is a company name tag or a ticker symbol then the page is a organization page;
(e3) searching the first five hundred characters of the page body for the phrase ‘, born’, ‘was born’, ‘(born’, or ‘born on ’, wherein if the first five hundred characters comprise any of the phrases then the page is a person page;
(e4) searching the first five hundred characters of the page for a date pattern, wherein if the first five hundred characters comprise the date pattern then the page is a person page.

5. The method of claim 1 wherein said determining in (c) comprises searching the content of the page.

6. The method of claim 5 wherein said searching comprises:
designating the page as a disambiguation page if a title of the page comprises the word “disambiguation” or if the page comprises a disambiguation tag; and
designating the page as a redirect page if the page a redirect tag.

7. The method of claim of claim 1 wherein said estimating in (d2) comprises computing the popularity according to the size of the page in characters (S), the number of pages to which it links (LO), the number of pages linking to it (LI).

8. The method of claim 7 wherein said computing further comprises additionally computing the popularity according to the number of page views (V).

9. The method of claim 1 wherein said providing comprises accessing the digital encyclopedia database over the internet.

10. The method of claim 1 wherein said providing comprises accessing an online collaborative encyclopedia.

11. A computer readable medium having instruction stored thereon instructions for creating a disambiguation database from a digital encyclopedia database, the digital encyclopedia database having a plurality of pages wherein each page includes content comprising a page body, a title, characters, and links, which when executed by a processor causes the processor to perform the steps of:
(a) providing a digital encyclopedia database;
(b) obtaining a list of the plurality of pages, and for each page the content, including the links;
(c) for each page of the list of pages, determining if the page is a disambiguation page or redirect page;
(d) if each page is a disambiguation or redirect page,
(d1) determining a page type; and
(d2) estimating a popularity of the page.

12. The computer readable medium of claim 11 further comprising instruction to perform the step of storing in a disambiguation database links to redirect pages, links to disambiguation pages, and for each redirect page and disambiguation page, the popularity of the page and the page type.

13. A computer program product for creating a disambiguation database from a digital encyclopedia database, the digital encyclopedia database having a plurality of pages wherein each page includes content comprising a page body, a title, characters, and links, the program product comprising:
a computer readable medium;
encyclopedia database means stored on said computer readable medium for providing a digital encyclopedia database;
obtaining means stored on said computer readable medium for obtaining a list of the plurality of pages, and for each page the content, including the links;
determining means stored on said computer readable medium for determining for each page of the list of pages if the page is a disambiguation page or redirect page;
determining page type means stored on said computer readable medium for determining the page type of each disambiguation or redirect page;
estimating popularity means stored on said computer readable medium for estimating a popularity of each disambiguation or redirect page; and
storing means stored on said computer readable medium for storing in a disambiguation database links to redirect pages, links to disambiguation pages, and for each redirect page and disambiguation page, the popularity of the page and the page type.
